(19) United States
(12) Patent Application Publication
(10) Pub. No.: US 2014/0274814 A1
(43) Pub. Date: Sep. 18, 2014

(54) Removable fluidics structures for microarray, microplates, sensor arrays, and other removable media

(71) Applicant: Lester Ludwig, San Antonio, TX (US)

(72) Inventor: Lester Ludwig, San Antonio, TX (US)

(21) Appl. No.: 13/815,757

(22) Filed: Mar. 15, 2013

(51) Int. Cl. G01N 35/10

(52) U.S. Cl. CPC G01N 35/1074
USPC 506/43

(57) ABSTRACT

A removable microfluidics structure comprising at least one actuated fluid delivery element, wherein the actuated fluid delivery element is a pump element of a valve element configured to control fluid delivery to or from a removable media detachably coupled with the removable microfluidics structure based on an actuation force. The actuation force is an external actuation force or an internal actuation force. The removable microfluidics structure may include an electromechnical actuator for providing the actuation force, such as a solenoid, a solenoid with an ferromagnetic core or a piezoelectric actuator. The removable microfluidics structure may further include a coupling mechanism for detachably coupling the removable microfluidics structure with the removable media, such as a cell array, such that when the microfluidics structure couples with the removable media, the microfluidics structure controls fluid delivery to or from a cell of the cell array.

### BACKGROUND OF THE INVENTION

1. Technical Field

The disclosed embodiments relate in general to the area of miniature bioechemical and chemical detectors for pathogens, biomarkers, toxins, and other materials and, more specifically, to removable fluidics structures for microarray, microplates, sensor arrays, and other removable media and the associated methods.

2. Description of the Related Art

There is a strong need for a miniature, low cost platform(s) for addressing practical problems associated with the biochemical and chemical detectors for pathogens, biomarkers, toxins, and other materials.

### SUMMARY OF THE INVENTION

The embodiments described herein are directed to methods and systems that substantially obviate one or more of the above and other problems associated with conventional technology.

In accordance with one aspect of the inventive concepts described herein, there is provided a removable microfluidics structure comprising at least one actuated fluid delivery element, wherein the actuated fluid delivery element is a pump element of a valve element configured to control fluid delivery to or from a removable media detachably coupled with the removable microfluidics structure based on an actuation force.

In one or more embodiments, the actuation force is an external actuation force.

In one or more embodiments, the actuation force is an internal actuation force.

In one or more embodiments, the removable microfluidics structure may further include an electromechanical actuator for providing the actuation force.

In one or more embodiments, the electromechanical actuator comprises a solenoid.

In one or more embodiments, the electromechanical actuator comprises a solenoid with an ferromagnetic core.

In one or more embodiments, the electromechanical actuator comprises a piezoelectric actuator.

In one or more embodiments, the removable microfluidics structure may further include coupling mechanism for detachably coupling the removable microfluidics structure with the removable media.

In one or more embodiments, the removable media is a cell array.

In one or more embodiments, when the microfluidics structure couples with the removable media, the microfluidics structure controls fluid delivery to or from a cell of the cell array.

In accordance with one aspect of the inventive concepts described herein, there is provided a base system comprising a removable microfluidics structure comprising at least one actuated fluid delivery element, wherein the actuated fluid delivery element is a pump element of a valve element configured to control fluid delivery to or from a removable media detachably coupled with the base system based on an actuation force, the base system further comprising a control logic for controlling the fluid delivery to or from a removable media.

In one or more embodiments, the actuation force is an external actuation force.

In one or more embodiments, the actuation force is an internal actuation force.

In one or more embodiments, the base system further comprises an electromechnical actuator for providing the actuation force.

In one or more embodiments, the electromechanical actuator comprises a solenoid.

In one or more embodiments, the electromechanical actuator comprises a solenoid with an ferromagnetic core.

In one or more embodiments, the electromechanical actuator comprises a piezoelectric actuator.

In one or more embodiments, the base system further comprises a coupling mechanism for detachably coupling the removable microfluidics structure with the removable media.

In one or more embodiments, the removable media comprises is a cell array.

In one or more embodiments, the when base system couples with the removable media, the microfluidics structure controls fluid delivery to or from a cell of the cell array.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive concepts. Specifically:

FIG. 1 illustrates an exemplary embodiment of a removable replaceable media element.

FIG. 2 illustrates an exemplary embodiment of a base unit with an integrated inventive microfluidics assembly.

FIG. 3a illustrates an abstract representation of an exemplary embodiment of a removable replaceable media element with a dedicated microfluidics assembly.

FIG. 3b illustrates an abstract representation of an exemplary embodiment of a removable replaceable media element with a removable microfluidics assembly.

FIG. 4 illustrates an exemplary embodiment, wherein the interfacing module can be configured to be inserted into either the base unit or attached to the removable replaceable media element in either a fixed or a replaceable arrangement.

FIG. 5 illustrates an exemplary high-level combined signal flow and fluidic flow representation of an exemplary embodiment of the invention.

FIG. 6a illustrates an exemplary embodiment, wherein a valve element is actuated using a solenoid.

FIG. 6b illustrates an exemplary embodiment, wherein a pump element is actuated using a solenoid.

FIG. 6c illustrates an exemplary embodiment, wherein a valve element is actuated using a solenoid having a movable ferromagnetic slug.

FIG. 6d illustrates an exemplary embodiment, wherein a pump element is actuated using a solenoid having a movable ferromagnetic slug.

FIG. 6e illustrates an exemplary embodiment, wherein a valve element is actuated using a piezo-electric actuator.

FIG. 6f illustrates an exemplary embodiment, wherein a pump element is actuated using a piezo-electric actuator.

FIG. 7a illustrates an exemplary embodiment of an illumination configuration involving a backside illumination of a valve element.

FIG. 7b illustrates an exemplary embodiment of an illumination configuration involving a backside illumination of a pump element.

FIG. 7c illustrates an exemplary, embodiment of an illumination configuration involving a frontside illumination of a valve element.

FIG. 7d illustrates an exemplary embodiment of an illumination configuration involving a frontside illumination of a pump element.

FIG. 8 illustrates an exemplary operational diagram of an embodiment of the invention.

FIG. 9a illustrates one exemplary embodiment of the invention having a removable microfluidics assembly electrically coupled with electronics of the base system and having a separate sample acquisition.

FIG. 9b illustrates one exemplary embodiment of the invention having a removable microfluidics assembly electrically coupled with electronics of the base system and having an integrated sample acquisition.

FIG. 9c illustrates one exemplary embodiment of the invention having an electromagnetically actuated removable microfluidics assembly and a separate sample acquisition.

FIG. 9d illustrates one exemplary embodiment of the invention having an electromagnetically actuated removable microfluidics assembly and an integrated sample acquisition.

FIG. 9e illustrates one exemplary embodiment of the invention having an otherwise actuated removable microfluidics assembly and a separate sample acquisition.

FIG. 9f illustrates one exemplary embodiment of the invention having an otherwise actuated removable microfluidics assembly and an integrated sample acquisition.

FIG. 9g illustrates one exemplary embodiment of the invention having an actuated removable microfluidics assembly electrically coupled with electronics of the base system and having a separate sample acquisition.

FIG. 9h illustrates one exemplary embodiment of the invention having an actuated removable microfluidics assembly electrically coupled with electronics of the base system and having an integrated sample acquisition.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

In accordance with one aspect of the inventive concepts described herein, there is provided a removable microfluidics structures for microarray, microplates, sensor arrays, and other removable media. In one or more embodiments, the removable microfluidics structure comprises at least one fluid delivery element. In one embodiment, the fluid delivery element is a pump element. In one embodiment, the fluid delivery element is a valve element. In one embodiment, the fluid delivery element is a tubing element. The fluid delivery element may be internally or externally actuated using solenoids, piezoelectric crystals or any other suitable means. In one embodiment, the microfluidics structure is integrated into a removable media, such as an array. In another embodiment, the microfluidics structures is detachably coupled with a removable media, such as an array media having an array of cells, such that each microfluidics structure couples with a cell of the array. In one embodiment, the microfluidics structures may be integrated into or detachably coupled with a base system. In one or more embodiments, the removable microfluidics structures may be microprocessor controlled using interface electronics.

FIG. 1 illustrates an exemplary embodiment of a removable replaceable media element 100. In one or more embodiments, the removable replaceable media element 100 comprises a single piece of transparent plastic material, such as Poly (methyl methacrylate), acrylic or any other suitable transparent material. The removable replaceable media element 100 may incorporate a plurality of cells 101 arranged in an array-like pattern. In one or more embodiments, the removable replaceable media element 100 is 3D-printetd in accordance with techniques well known to persons of skill in the art.

FIG. 2 illustrates an exemplary embodiment of a base system 200 with an integrated or removable inventive microfluidics subassembly 201. The shown embodiment of the microfluidics subassembly 201 incorporates multiple valves 202, tubing 203, pumps 204 configured to appropriately deliver fluid sample materials to or from the cells 101 of the removable replaceable media element 100 shown in FIG. 1. The valves 202 and/or pumps 204 may be internally or externally actuated using one of the actuation mechanisms described in detail below.

FIG. 3a illustrates an abstract representation of an exemplary embodiment of a removable replaceable media element 100 with an integrated dedicated microfluidics subassembly 201. The cells 101 of the replaceable media element 100 include cells 304 loaded with reagents such as printed depositions of solvent-soluble reagent solids or gels, cells 305 loaded as sensors with printed depositions of insoluble layered sensor materials as well as unloaded cells 306. The dedicated microfluidics subassembly 201 is integrated within the removable replaceable media element 100 such that the valves 202, tubing 203, and/or pumps 204 of the microfluidics subassembly 201 are coupled with the appropriate cells 101 to enable fluid delivery.

In addition, in one or more embodiments, the removable replaceable media element 100 comprises a memory unit 301, such a read-only memory unit (ROM) or other non-volatile data storage device, of optical, electronic and/or magnetic type for storing data 302 describing the content of the array of cells 101. In addition, the memory unit 301 may store algorithms 303 for processing any information associated with the array of cells 101.

FIG. 3b illustrates an abstract representation of an exemplary embodiment of a removable replaceable media element with a removable microfluidics assembly. The cells 101 of the replaceable media element 100 include cells 304 loaded with reagents, cells 305 loaded as sensors as well as unloaded cells 306. The dedicated microfluidics subassembly 201 is detachably coupled with the removable replaceable media element 100 such that the valves 202, tubing 203, and/or pumps 204 of the microfluidics subassembly 201 are coupled with the appropriate cells 101 to enable fluid delivery.

In addition, in one or more embodiments, the removable replaceable media element 100 of FIG. 3b comprises a memory unit 301, such a read-only memory unit (ROM) or other non-volatile data storage device, for storing data 302 describing the content of the array of cells 101. In addition, the memory unit 301 may store algorithms 303 for processing any information associated with the array of cells 101.

FIG. 4 illustrates an exemplary embodiment, wherein the interfacing module 400 can be configured to be inserted into either the base unit or attached to the removable replaceable media element 100 in either a fixed or a replaceable arrangement. The interfacing module 400 comprises the microfluidics elements including valves 202, tubing 203, and/or pumps 204. When the interfacing module 400 is mated with the replaceable media element 100, the aforesaid microfluidics elements (valves 202, tubing 203, and/or pumps 204) of the interfacing module 400 couple with the appropriate cells 101 of the removable replaceable media element 100 to enable fluid delivery. The valves 202 and/or pumps 204 of the interfacing module 400 may be internally or externally actuated using one of the actuation mechanisms described in detail below.

FIG. 5 illustrates an exemplary high-level combined signal flow and fluidic flow representation of an exemplary embodiment of the invention. The overall operation of the exemplary embodiment of the invention is controlled by the microprocessor 500. The electronics 501 is provided for interfacing the microprocessor 500 with the sensors disposed within the removable replaceable media element 100 and for receiving the data from the aforesaid sensors. On the other hand, the optoelectronics 502 is used for reading optical information related to the content of the cells 101 loaded with reagents. The data medium interface interfaces the microprocessor 500 with the memory unit 301 located on the removable replaceable media element 100 for facilitating read-out of the data and algorithms stored in that memory unit 301.

Electronics 504 interfaces the microprocessor 500 with the active controlled microfluidics 505, which are controlled by the microprocessor 500 to provide appropriate fluid delivery. Additionally provided is a passive microfluidics 506 and the replaceable removable interface module 400 described above.

FIG. 6a illustrates an exemplary embodiment, wherein a valve element 202 is actuated using a solenoid 601. FIG. 6b illustrates an exemplary embodiment, wherein a pump element 204 is actuated using a solenoid 601.

FIG. 6c illustrates an exemplary embodiment, wherein a valve element 202 is actuated using a solenoid 602 having a movable ferromagnetic slug 604.

FIG. 6d illustrates an exemplary embodiment, wherein a pump element 204 is actuated using a solenoid 602 having a movable ferromagnetic slug 604.

FIG. 6e illustrates an exemplary embodiment, wherein a valve element 202 is actuated using a piezo-electric actuator 603.

FIG. 6f illustrates an exemplary embodiment, wherein a pump element 204 is actuated using a piezo-electric actuator 603. It should be noted that the inventive concepts described herein are not limited to the shown actuation methods and any other mow know or later developed actuation techniques for the aforesaid microfluidics elements (valves 202, tubing 203, and/or pumps 204) can similarly be used.

FIG. 7a illustrates an exemplary embodiment of an illumination configuration involving a backside illumination of a valve element 202 using a light from a light source 701. In the shown embodiment, the light transmitted by the valve element 202 is collected by the light sensor 702.

FIG. 7b illustrates an exemplary embodiment of an illumination configuration involving a backside illumination of a pump element 204 using a light from a light source 701. In the shown embodiment, the light transmitted by the pump element 204 is collected by the light sensor 702.

FIG. 7c illustrates an exemplary embodiment of an illumination configuration involving a frontside illumination of a valve element 202 using a light from a light source 701. In the shown embodiment, the light reflected by the valve element 202 is collected by the light sensor 702.

FIG. 7d illustrates an exemplary embodiment of an illumination configuration involving a frontside illumination of a pump element 204 using a light from a light source 701. In the shown embodiment, the light reflected by the pump element 204 is collected by the light sensor 702.

FIG. 8 illustrates an exemplary operational diagram of an embodiment of the invention. In the shown embodiment, the information from the sensor 801 is processed and analyzed by electronics 802, which controls electromechanical actuator 803 based on the information received from the sensor 801. The elctromechanical actuator, which may include structures shown in any of the FIGS. 6a-6f, controls the aforesaid microfluidics elements (valves 202, tubing 203, and/or pumps 204), which, in turn, control the fluid flow to the sensor 801.

FIG. 9a illustrates one exemplary embodiment of the invention having a removable microfluidics sub-assembly 201 electrically coupled with electronics of the base system 900 and having a separate sample acquisition module 902. The shown embodiment incorporates a microprocessor 500 disposed in a small base system 900, which performs overall control of the operation of the shown embodiment. The electronics 501 interfaces the microprocessor 500 with the removable microfluidics sub-assembly 201. The removable microfluidics sub-assembly. 201 may also be configured directly by the microprocessor 500. Additionally provided is opto-electronics 502 for obtaining optical readout from at least some of the cells 101 in the cell matrix of the removable replaceable media element 100. In the shown embodiment, the sample acquisition is separate from the removable microfluidics sub-assembly 201.

FIG. 9b illustrates one exemplary embodiment of the invention having a removable microfluidics sub-assembly 201 electrically coupled with electronics of the base system 900 and having an integrated sample acquisition module 902. The shown embodiment incorporates a microprocessor 500 disposed in a small base system 900, which performs overall control of the operation of the shown embodiment. The electronics 501 interfaces the microprocessor 500 with the removable microfluidics sub-assembly 201. The removable microfluidics sub-assembly 201 may also be configured directly by the microprocessor 500. Additionally provided is opto-electronics 502 for obtaining optical readout from at least some of the cells 101 in the cell matrix of the removable replaceable media element 100. In the shown embodiment, the sample acquisition is separate from the removable microfluidics sub-assembly 201.

FIG. 9c illustrates one exemplary embodiment of the invention having an electromagnetically actuated removable microfluidics assembly 201 and a separate sample acquisition module 902. The shown embodiment incorporates a microprocessor 500 disposed in a small base system 900, which performs overall control of the operation of the shown embodiment. The electronics 501 interfaces the microprocessor 500 with the removable microfluidics sub-assembly 201. The removable microfluidics sub-assembly 201 may also be configured directly by the microprocessor 500. Additionally provided is opto-electronics 502 for obtaining optical readout from at least some of the cells 101 in the cell matrix of the removable replaceable media element 100. In the shown embodiment, the sample acquisition is separate from the removable microfluidics sub-assembly 201. The removable microfluidics sub-assembly 201 is actuated using the electromagnetic actuator 903 controlled by the microprocessor 500.

FIG. 9d illustrates one exemplary embodiment of the invention having an electromagnetically actuated removable microfluidics assembly 201 and an integrated sample acquisition module 902. The shown embodiment incorporates a microprocessor 500 disposed in a small base system 900, which performs overall control of the operation of the shown embodiment. The electronics 501 interfaces the microprocessor 500 with the removable microfluidics sub-assembly 201. The removable microfluidics sub-assembly 201 may also be configured directly by the microprocessor 500. Additionally provided is opto-electronics 502 for obtaining optical readout from at least some of the cells 101 in the cell matrix of the removable replaceable media element 100. In the shown embodiment, the sample acquisition is separate from the removable microfluidics sub-assembly 201. The removable microfluidics sub-assembly 201 with integrated sample acquisition module 902 is actuated using the electromagnetic actuator 903 controlled by the microprocessor 500.

FIG. 9e illustrates one exemplary embodiment of the invention having an otherwise actuated removable microfluidics assembly and a separate sample acquisition module 902. The shown embodiment incorporates a microprocessor 500 disposed in a small base system 900, which performs overall control of the operation of the shown embodiment. The electronics 501 interfaces the microprocessor 500 with the removable microfluidics sub-assembly 201. The removable microfluidics sub-assembly 201 may also be configured directly by the microprocessor 500. Additionally provided is opto-electronics 502 for obtaining optical readout from at least some of the cells 101 in the cell matrix of the removable replaceable media element 100. In the shown embodiment, the sample acquisition is separate from the removable microfluidics sub-assembly 201. The removable microfluidics sub-assembly 201 is actuated using the other actuator 907 controlled by the microprocessor 500.

FIG. 9f illustrates one exemplary embodiment of the invention having an otherwise actuated removable microfluidics assembly and an integrated sample acquisition module 902. The shown embodiment incorporates a microprocessor 500 disposed in a small base system 900, which performs overall control of the operation of the shown embodiment. The electronics 501 interfaces the microprocessor 500 with the removable microfluidics sub-assembly 201. The removable microfluidics sub-assembly 201 may also be configured directly by the microprocessor 500. Additionally provided is opto-electronics 502 for obtaining optical readout from at least some of the cells 101 in the cell matrix of the removable replaceable media element 100. In the shown embodiment, the sample acquisition is separate from the removable microfluidics sub-assembly 201. The removable microfluidics sub-assembly 201 with an integrated sample acquisition module 902 is actuated using the other actuator 907 controlled by the microprocessor 500.

FIG. 9g illustrates one exemplary embodiment of the invention having an actuated removable microfluidics assembly 201 electrically coupled with electronics module 501 of the base system 900 and having a separate sample acquisition module 902. The shown embodiment incorporates a microprocessor 500 disposed in a small base system 900, which performs overall control of the operation of the shown embodiment. The electronics 501 interfaces the microprocessor 500 with the removable microfluidics sub-assembly 201. The removable microfluidics sub-assembly 201 may also be configured directly by the microprocessor 500. Additionally provided is opto-electronics 502 for obtaining optical readout from at least some of the cells 101 in the cell matrix of the removable replaceable media element 100. In the shown embodiment, the sample acquisition is separate from the removable microfluidics sub-assembly 201. The removable microfluidics sub-assembly 201 is actuated using the actuator 904 controlled by the microprocessor 500.

FIG. 9h illustrates one exemplary embodiment of the invention having an actuated removable microfluidics assembly 201 electrically coupled with electronics module 501 of the base system 900 and having an integrated sample acquisition module 902. The shown embodiment incorporates a microprocessor 500 disposed in a small base system 900, which performs overall control of the operation of the shown embodiment. The electronics 501 interfaces the microprocessor 500 with the removable microfluidics sub-assembly 201. The removable microfluidics sub-assembly 201 may also be configured directly by the microprocessor 500. Additionally provided is opto-electronics 502 for obtaining optical readout from at least some of the cells 101 in the cell matrix of the removable replaceable media element 100. In the shown embodiment, the sample acquisition is separate from the removable microfluidics sub-assembly 201. The removable microfluidics sub-assembly 201 with an integrated sample acquisition module 902 is actuated using the actuator 904 controlled by the microprocessor 500.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, perl, shell, PHP, Java, as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in the removable microfluidics structures and the associated systems and methods. It is intended that the specification and examples be considered as exemplary only, with a true scope and spirit of the invention being indicated by the following claims.

What is claimed is:

1. A removable microfluidics structure comprising at least one actuated fluid delivery element, wherein the actuated fluid delivery element is a pump element of a valve element configured to control fluid delivery to or from a removable media detachably coupled with the removable microfluidics structure based on an actuation force.

2. The removable microfluidics structure of claim 1, wherein the actuation force is an external actuation force.

3. The removable microfluidics structure of claim 1, wherein the actuation force is an internal actuation force.

4. The removable microfluidics structure of claim 1, further comprising an electromechanical actuator for providing the actuation force.

5. The removable microfluidics structure of claim 4, wherein the electromechanical actuator comprises a solenoid.

6. The removable microfluidics structure of claim 4, wherein the electromechanical actuator comprises a solenoid with an ferromagnetic core.

7. The removable microfluidics structure of claim 4, wherein the electromechanical actuator comprises a piezoelectric actuator.

8. The removable microfluidics structure of claim 1, further comprising a coupling mechanism for detachably coupling the removable microfluidics structure with the removable media.

9. The removable microfluidics structure of claim 1, wherein the removable media is a cell array.

10. The removable microfluidics structure of claim 9, wherein when the microfluidics structure couples with the removable media, the microfluidics structure controls fluid delivery to or from a cell of the cell array.

11. A base system comprising a removable microfluidics structure comprising at least one actuated fluid delivery element, wherein the actuated fluid delivery element is a pump element of a valve element configured to control fluid delivery to or from a removable media detachably coupled with the base system based on an actuation force, the base system further comprising a control logic for controlling the fluid delivery to or from a removable media.

12. The base system of claim 11, wherein the actuation force is an external actuation force.

13. The base system of claim 11, wherein the actuation force is an internal actuation force.

14. The base system of claim 11, further comprising an electromechnical actuator for providing the actuation force.

15. The base system of claim 14, wherein the electromechnical actuator comprises a solenoid.

16. The base system of claim 14, wherein the electromechnical actuator comprises a solenoid with an ferromagnetic core.

17. The base system of claim 14, wherein the electromechnical actuator comprises a piezoelectric actuator.

18. The base system of claim 11, further comprising a coupling mechanism for detachably coupling the removable microfluidics structure with the removable media.

19. The base system of claim 11, wherein the removable media comprises is a cell array.

20. The base system of claim 19, wherein when the base system couples with the removable media, the microfluidics structure controls fluid delivery to or from a cell of the cell array.
